(19) United States
(12) Patent Application Publication
(10) Pub. No.: US 2008/0168381 A1
(43) Pub. Date: Jul. 10, 2008

(54) NON-MODAL SEARCH BOX WITH TEXT-ENTRY RIBBON FOR A PORTABLE MEDIA PLAYER

(75) Inventors: Jonathan Nelson, Seattle, WA (US); David Schultz, Seattle, WA (US); Jenny Lai, Seattle, WA (US)

Correspondence Address: PERKINS COIE LLP;PATENT-SEA, P.O. BOX 1247, SEATTLE, WA, 98111-1247, US

(73) Assignee: AOL LLC

(21) Appl. No.: 11/848,197

(22) Filed: Aug. 30, 2007

Related U.S. Application Data
(60) Provisional application No. 60/883,984, filed on Jan. 8, 2007.

(51) Int. Cl. G06F 3/048; G06F 17/30

(52) U.S. Cl. 715/780

(57) ABSTRACT

A non-modal search box with a text-entry ribbon for a portable media player. The non-modal search box enables a user to quickly and efficiently locate media on the portable media player, without having to enter a specific search mode. The non-modal search box may be present on one or more media player screens, without the user first having to select a search option or otherwise indicate a desire to search for a piece of media. The non-modal search box allows a user to navigate between the search box and search results without having to switch modes. The search box is an input box for character entry. The search box may utilize a text-entry ribbon to allow a user to input characters into the search box.

### CROSS-REFERENCE TO RELATED APPLICATION(S)

This application claims priority to, and incorporates by reference in its entirety, U.S. Provisional Application No. 60/883,984, filed on Jan. 8, 2007.

### BACKGROUND

Portable media players are increasing in popularity. A portable media player is a transportable device that plays one or more media file types, including text, audio, video, graphics, animation, images, interactive, and other media file types.

A variety of pieces of media can be stored on a portable media player, and it is desirable for a user to be able to locate a piece of media quickly and efficiently. Many portable media players allow a user to scroll through an alphabetical list of media in order to locate a desired piece of media. The list may include song titles, album titles, video titles, artist names, genres and/or other items. Scrolling through a list of media, however, may be unwieldy and time consuming when the list contains many items. To improve search functionality, some portable media players have incorporated a scroll function that accelerates as the user continues to scroll. By allowing the user to scroll through items more quickly, the user is able to locate desired media more quickly. Unfortunately, for many users the accelerated scroll function may move too quickly, causing the user to overshoot the desired piece of media. A quicker and more efficient method of locating a piece of media in a portable media player is therefore desired.

### BRIEF DESCRIPTION OF THE DRAWINGS

FIG. 1 is a block diagram of components in a portable media player.

FIGS. 2A, 2B, and 2C are representative screenshots depicting various modes of a search box and a text entry ribbon on a portable media player screen.

FIGS. 3A, 3B, and 3C are a succession of representative screenshots depicting a search box and a text-entry ribbon that move off a portable media player screen as a user scrolls in a downward motion.

FIGS. 4A, 4B, and 4C are a succession of representative screenshots depicting a search box and text-entry ribbon that remain in fixed locations on a portable media player screen as a user scrolls in a downward motion.

FIG. 5 is a representative screenshot depicting a search box and a text-entry ribbon on a portable media player screen.

FIG. 6 is a representative screenshot depicting symbol, number, uppercase, and space characters in a text-entry ribbon for a portable media player.

### DETAILED DESCRIPTION

A non-modal search box with a text-entry ribbon for a portable media player is described. The non-modal search box enables a user to quickly and efficiently locate media on the portable media player, without having to enter a specific search “mode.” That is, a search box may be present on a media player screen without the user first having to select a “search” option or otherwise indicate to a desire to search for a piece of media. Further, the non-modal search box allows a user to navigate between the search box and search results without having to switch “modes.” For example, the user may scroll in one direction (e.g., horizontally) to use the text-entry ribbon to populate the search box, while the user may scroll in another direction (e.g., vertically) to move between the search box and the search results. One skilled in the art will appreciate that other benefits may also be achieved with a non-modal search box.

The non-modal search box is an input box for character entry that allows a user to locate a desired piece of media or other item on a portable media player. The non-modal search box may utilize a text-entry ribbon to allow a user to input characters into the search box. The text-entry ribbon allows a user to quickly enter text on the portable media player even though a portable media player typically lacks a keyboard. One skilled in the art will appreciate that the non-modal search box may be used with a method of character entry other than a text-entry ribbon, such as a keyboard, stylus or other writing implement, voice-recognition software, or other method of character entry.

The following description provides specific details for a thorough understanding of, and enabling description for, various embodiments of the technology. One skilled in the art will understand that the technology may be practiced without many of these details. In some instances, well-known structures and functions have not been shown or described in detail to avoid unnecessarily obscuring the description of the embodiments of the technology. It is intended that the terminology used in the description presented below be interpreted in its broadest reasonable manner, even though it is being used in conjunction with a detailed description of certain embodiments of the technology. Although certain terms may be emphasized below, any terminology intended to be interpreted in any restricted manner will be overtly and specifically defined as such in this Detailed Description section.

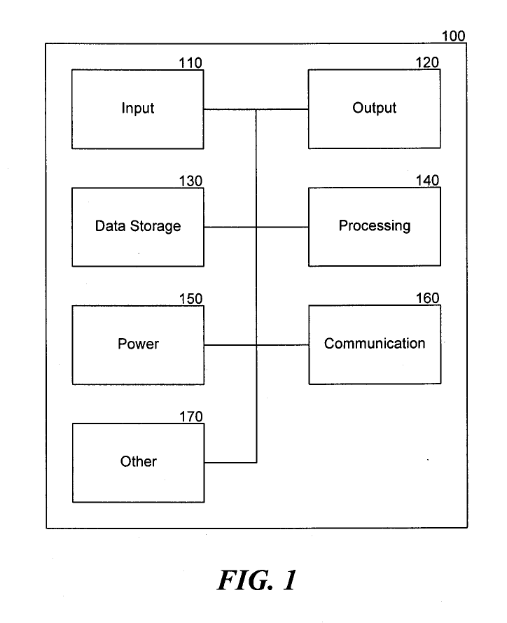

FIG. 1 is a block diagram illustrating representative components of a portable media player 100. Portable media player 100 may include an input component 110 and an output component 120. Input component 110 receives user input from one or more input controls, such as buttons, scroll wheels, touchpads, and so on. Output component 120 provides output to a user, and may include an audio playback module, a display module, and so on. Portable media player 100 also includes a data storage component 130. Data storage component 130 may be a magnetic media drive, optical media drive, other non-volatile memory, flash memory, and so on, capable of storing operational software and audio media, video media, image media, and other media types for playback via output component 120. The portable media player may also include a processing component 140 for implementing various software processes, such as searches, filtering, and other data manipulation on the media player, a power component 150 that supplies power to the player and the components of the player, and a communication component 160 that communicates with other devices and networks, such as via a wireless network. Examples of communication include wired communication, such as over a USB or firewire connection, wireless communication, such as via 802.11 based networks, and so on. Player 100 may also include other components 170, such as components for establishing mobile phone connections, not specifically described herein.

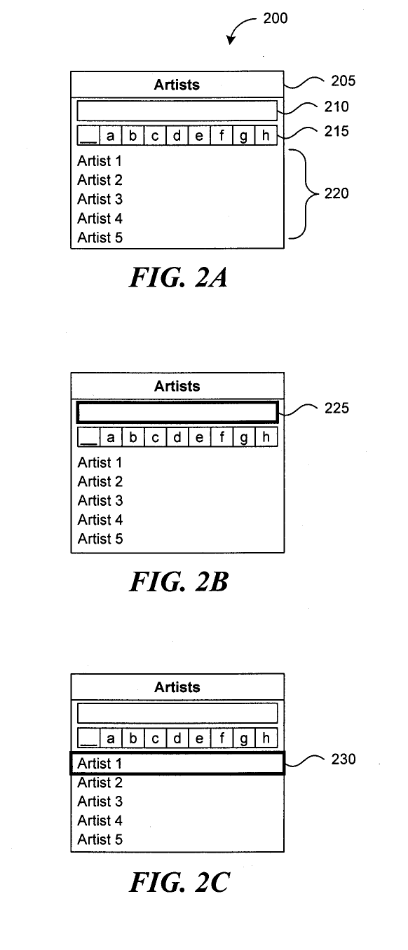

A non-modal search box and/or the text-entry ribbon may be present on one or more screens displayed by the portable media player. For example, the search box and text-entry ribbon may be present on a screen that lists albums, artists, songs, videos, genres, and/or other information. FIG. 2A is a representative screen shot 200 that depicts a search box 210 and a text-entry ribbon 215 on an Artists screen 205. The Artists screen 205 includes a list of artists 220 of pieces of media contained on a media player. The search box and text-entry ribbon may be presented as part of the screen (e.g., at the top or bottom of the screen), as a pop up window, or in another manner. For example, the search box and text-entry ribbon may be presented at the top of the screen, followed by a list of albums, artists, songs, genres, or other information, depending on the screen the user has chosen. FIG. 2A is an example of a search box 210 and text-entry ribbon 215 displayed at the top of an Artists screen 205, followed by a list of artists 220. One skilled in the art will appreciate that the search box may be displayed in a number of other ways, including as a result of a manual selection made by the user.

When a screen is displayed that contains a non-modal search box and/or the text-entry ribbon, the focus may initially be on the search box, the first list item, or another item or area of the screen. “Focus” is that portion of the screen that is active, or selectable, and is typically indicated in a graphical manner to a user. For example, when focus is on the search box, the user may enter characters into the search box; when focus is on a media file (e.g., song 1), the user may play the media file. FIG. 2B is a representative screen shot that depicts focus 225 on the search box, as indicated by the bold line around the search box. FIG. 2C is a representative screen shot that depicts focus 230 on the first list item, Artist 1, as indicated by the bold line around Artist 1.

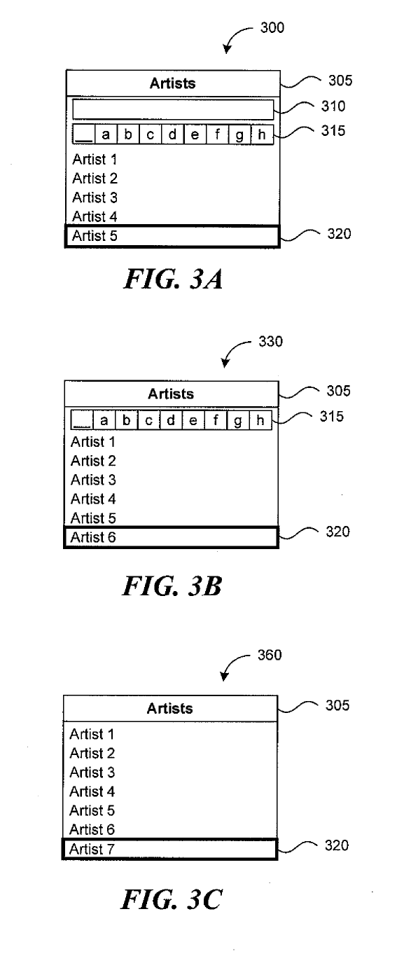

The non-modal search box and/or the text-entry ribbon may remain in fixed locations on the screen, or the search box and/or the text-entry ribbon may scroll off of the screen. For example, if the search box and text-entry ribbon are present at the top of a screen, and the user scrolls in a downward motion (i.e., from the search box and text-entry ribbon to a list of search results), the search box and/or text-entry ribbon may scroll off the screen when the user scrolls beyond the last search result entry on the screen. In other words, the search box and/or the text-entry ribbon may act like list items, scrolling off of the screen as the user indicates a desire to display subsequent (or previous) list items. FIGS. 3A, 3B, and 3C are a succession of representative screen shots 300, 330, and 360 that depict a search box 310 and text-entry ribbon 315 that scroll off the screen as a user scrolls in a downward motion. FIG. 3A depicts the search box 310 and text-entry ribbon 315 at the top of an Artists screen 305. Focus 320 is on Artist 5, as indicated by the bold box around Artist 5. FIG. 3B depicts the text-entry ribbon 315 at the top of the Artists screen 305, as the user has scrolled downward from Artist 5 to Artist 6. Focus 320 is on Artist 6, and the search box has scrolled off the top of the screen. FIG. 3C depicts that both the search box and the text-entry ribbon have scrolled off the top of the screen as the user has scrolled downward from Artist 6 to Artist 7. Focus 320 is now on Artist 7. If the user scrolls in an upward motion, the search box and/or text-entry ribbon may re-appear at the top of the screen when the top of the list is displayed on the screen.

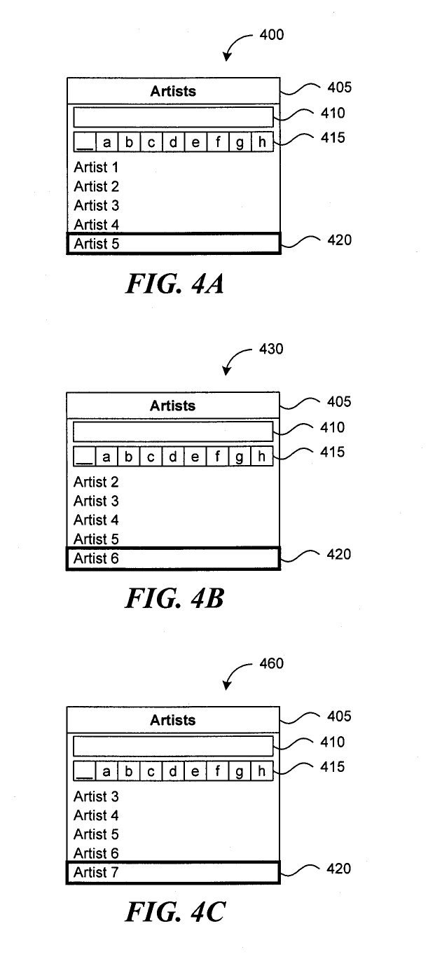

Alternatively, FIGS. 4A, 4B, and 4C are a succession of representative screen shots 400, 430, and 460 that depict a search box 410 and text-entry ribbon 415 that remain in fixed locations on the screen. FIG. 4A depicts the search box 410 and text-entry ribbon 415 at the top of an Artists screen 405. Focus 420 is on Artist 5. FIG. 4B depicts that the search box 410 and text-entry ribbon 415 remain at the top of the Artists screen 405 as the user has scrolled downward from Artist 5 to Artist 6. Focus 420 is on Artist 6. Similarly, FIG. 4C depicts that the search box 410 and text-entry ribbon 415 remain at the top of the Artists screen 405 as the user has continued to scroll downward from Artist 6 to Artist 7. Focus 420 is now on Artist 7.

When the search box is selected, the appearance of the search box may change to show that the search box is active. For example, the search box may be bolded, highlighted, or otherwise distinguished from its unselected, or inactive, state. FIG. 2B illustrates a search box that is bolded to indicate that focus 225 is on the search box.

Once the search box has been selected by the user or by the media player, the user gains the ability to enter characters into the search box. The characters entered into the search box are referred to as a search string. Text-entry is only active, whether through the text-entry ribbon or another method of text-entry, when the search box is selected, or active. In other words, de-selecting the search box (e.g., by scrolling away from the search box) concludes the user's ability to enter text into the search box. The user can regain the ability to enter text by re-selecting the search box (e.g., by scrolling back to the search box).

The search box may initially be empty or, alternatively, it may be populated with one or more characters. If the search box is empty, a cursor may appear at the beginning (e.g., left side for English text entry) of the box. If the search box contains one or more characters, a cursor may appear following the last character in the box.

The search box may be populated differently depending on whether the user navigates forward to the search box (e.g., initially accessing a screen that contains a searchable list) or backward to the search box (e.g., re-accessing a screen that contains a searchable list, after having conducted a search and selected one or more search results). For example, a search box to which the user navigates forward may be empty, while a search box to which the user navigates backward may contain the search string as entered by the user. In addition, focus may be on a different item depending on whether the user navigates forward or backward to the search box. For example, focus may be on a first list item when the user navigates forward to a searchable list, while focus may be on a selected list item when the user navigates backward to a searchable list.

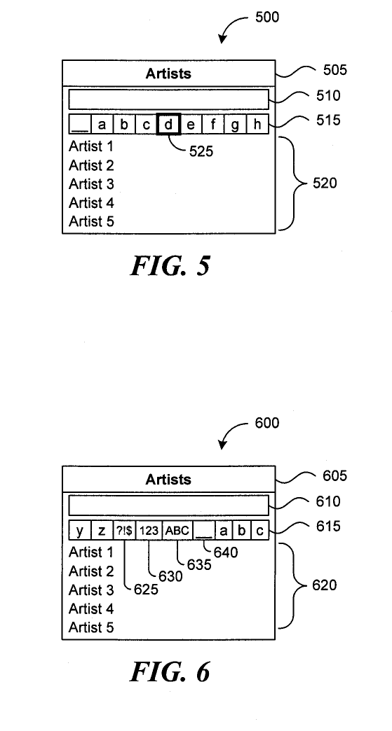

When the search box is selected, a text-entry ribbon may appear. The text-entry ribbon is a horizontal row of characters that may extend the entire width of the screen, or any portion thereof. FIG. 5 is a representative screenshot 500 that depicts a search box 510 at the top of an Artists screen 505 and a text-entry ribbon 515 immediately below the search box 510. The text-entry ribbon may display three or more characters on the screen at a time. The text-entry ribbon may be presented as part of the screen, as a pop up window, or in another manner. The user scrolls through the text-entry ribbon (e.g., by moving a scroll wheel or scroll pad left or right) to select a character for entry into the search box. The selected character is designated by a selection indicator, such as an arrow, a bolded font, highlighted box, or other indicator. FIG. 5 illustrates a bolded box 525 surrounding a selected character, “d.” In some embodiments, the character available for selection is the character in the middle of the ribbon, as depicted in FIG. 5. However, one skilled in the art will appreciate that the character available for selection may be located anywhere along the text-entry ribbon. The user may confirm that a selected character should be entered into the search box by pressing an input button or otherwise indicating that the user wishes to use the selected character. The text-entry ribbon operates as a seamless loop. The last character in the set is succeeded by the first character; and the first character in the set is preceded by the last character. Those skilled in the art will appreciate that while a horizontal text-entry ribbon may be the most intuitive for English text-entry, it may be desirable to employ a vertical text-entry ribbon for aesthetic reasons or in certain cases such as foreign character sets or reduced character sets.

The text-entry ribbon may be populated with one or more sets of characters. In some embodiments, the text-entry ribbon may be populated with the following sets of characters: uppercase, lowercase, numbers, and symbols. In some embodiments, only one set of characters may be displayed at a time in the text-entry ribbon, e.g., only lowercase characters will be displayed in the text-entry ribbon. A special icon in the selected character set may allow the user to switch to another character set. For example, when the lowercase character set is displayed on the text-entry ribbon, a user may be able to switch to the uppercase character set by selecting an icon representing uppercase characters (e.g., a string “ABC” In the text ribbon). Similarly, the number character may be represented by an icon of the string “123” and the symbol character may be represented by an icon of the string “?!$.” In addition, one or more of the character sets may contain a character for a space, which may be represented as an underscore (“ ”) FIG. 6 is a representative screenshot 600 depicting a symbol character 625, a number character 630, an uppercase character 635, and a space character 640 in the text-entry ribbon 615. Character sets may also include characters of languages other than English. When the user selects a search box, the text-entry ribbon may be populated with a default character set, e.g., the lowercase set.

While using a text-entry ribbon that displays one character set, pressing and holding an input button on a selected character (or any other action that indicates a desire to select a character) may allow the user to input a character other than one that is in the current character set. For example, pressing and holding an input button may allow the user to input an uppercase letter that corresponds to the lowercase letter that is selected (e.g., a user pressing and holding on the lowercase character “c” will result in insertion of the uppercase character “C”). Pressing and holding an input button on a character may also allow the user to input an accented character (e.g., A or A) or other special character.

In some embodiments, a display of search results that are displayed beneath the search box may be refined each time the user enters an additional character into the search box. For example, if the user first enters “a,” only those items that begin with “a” will be displayed. If the user next enters “b” following the “a,” the list of results will be reduced such that only those items that begin with “ab” will be displayed. At any time during the search, the user may select one of the search results displayed. The user may do so by, for example, scrolling down the search results list to the desired item. By doing so, the user also scrolls off of the search box, deactivating text entry until the user reselects (e.g., scrolls back up to) the search box.

Characters entered into the search box may be deleted, such as by pressing a “back” button or by selecting a “delete” icon on the text ribbon. One skilled in the art will appreciate that there are other ways to delete characters. In some embodiments, pressing the back button once will result in the deletion of the previous character entered. Pressing and holding the back button will result in characters being deleted until the button is released or until the last character in the search box has been deleted. Pressing the back button when there are no characters in the search box will result in directing the user back to the previous media player screen.

In some embodiments, the search conducted via the search box will only display those results for which the first letter(s) of the first word of the item matches the search string entered by the user. In such embodiments, for example, a search for “b” will not return “The Beatles.” In other embodiments, the search will display those results for which the first letter(s) of any word in the item matches the search string entered by the user. In these embodiments, for example, a search for “b” will return “The Beatles.”

In some embodiments, search results may be displayed in alphabetical order. In other embodiments, search results may be displayed such that those items that have a first word that begins with the search string are displayed above those in which a subsequent word begins with the search string, even if this does not reflect alphabetical order. In other embodiments, search results may be displayed in an order such that the items that are predicted to be most relevant to all users or a particular user may be displayed above those items that are predicted to be less relevant.

A search box may have a minimum and/or maximum number of characters that may be entered. If a user enters fewer than the minimum number of characters, a search or other function desired by the user will not proceed until the minimum number of characters is entered. A warning indicator, such as a pop up box or other indicator, may signal to the user that more characters must be entered before the search or other function can occur. If a user attempts to enter more than the maximum number of characters, no characters beyond the maximum will be inserted into the search box. A warning indicator, such as a pop up box or other indicator, may signal to the user that the character limit has been reached.

The rate at which a user may scroll through the characters in the text ribbon may be constant, or it may accelerate the longer the user continues to scroll. The rate at which a user may scroll may also be related to the speed at which the user moves his or her thumb or finger on a scroll pad or scroll wheel or otherwise indicates that the user wishes to scroll through the characters.

A predictive algorithm or other method may be used to increase the speed with which a user can enter characters. The predictive algorithm may limit the number of characters in the text ribbon to those characters that lead to a search term that provides meaningful search results. For example, if a user enters the characters “sou” and there are only two artists in a media player that will be found by such a search (e.g., Soundgarden and Soup Dragons), the characters in the text ribbon may be restricted to “n” and “p.”

A text-entry input box may also be used outside of the search context. For example, the user may activate a text-entry input box by choosing “edit” from a list of one or more options. The user may use the text-entry input box to modify the name of a file, song title, artist name, or other item.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

We claim:

1. A system for locating and selecting objects on a portable media device, the system comprising:
an input component for receiving a character string selected by a user from characters displayed on a screen of the portable media device, wherein the character string comprises one or more characters indicative of one or more objects located on the portable media device;
a filtering component for identifying a list of objects located on the portable media device that are associated with the character string received by the input component;
a display component for simultaneously displaying to the user the character string received by the input component and the list of objects identified by the filtering component; and
a navigation component that allows the user to move between the character string displayed by the display component and the list of objects displayed by the display component, wherein the user may modify the character string when the user has navigated to the character string and the user may select an object from the list of objects when the user has navigated to the list of objects.

2. The system of claim 1 wherein the input component comprises:
a text-entry component comprising a list of individually-selectable characters that allows the user to enter a character; and
a string display component that displays one or more entered characters by the user.

3. The system of claim 2 wherein the list of individually-selectable characters is a lowercase alphabet presented in alphabetical order.

4. The system of claim 2 wherein the list of individually-selectable characters is an uppercase alphabet presented in alphabetical order.

5. The system of claim 2 wherein the list of individually-selectable characters is a list of single integers presented in numerical order.

6. The system of claim 2 wherein the list of individually-selectable characters is a list of symbols.

7. The system of claim 2 wherein the text-entry component is only enabled when the user has navigated to the text-entry component.

8. The system of claim 1 wherein the user may traverse the list of displayed objects and the character string is displayed to the user in a fixed location as the user traverses the list.

9. The system of claim 2 wherein the user may traverse the list of displayed objects and the text-entry component and string display are displayed to the user in a fixed location as the user traverses the list.

10. The system of claim 1 wherein the user may traverse the list of displayed objects and the character string is no longer displayed to the user after the user traverses a certain distance in the list.

11. The system of claim 2 wherein the user may traverse the list of displayed objects and the text-entry component and string display are no longer displayed after the user traverses a certain distance in the list.

12. The system of claim 2 wherein the string display is pre-populated with a character string.

13. The system of claim 2 wherein the string display initially contains no character string.

14. The system of claim 2 wherein a user action associated with an individually-selectable character causes a character other than the individually-selectable character to be entered.

15. The system of claim 1 wherein the filtering component generates a list of objects each time the user adds a new character to the character string or modifies the character string.

16. The system of claim 15 wherein the display component displays the list of objects each time the filtering component generates a list of objects.

17. The system of claim 1 wherein objects are associated with the character string when a first word in a title of the object begins with the character string.

18. The system of claim 1 wherein objects are associated with the character string when any word in a title of the object begins with the character string.

19. The system of claim 1, wherein the objects are media files.

20. A method of locating and selecting objects on a portable media device, the method comprising:
receiving a character string from a user, wherein the character string is selected by the user from characters displayed on a screen of the portable media device, and wherein the character string comprises one or more characters indicative of one or more objects located on the portable media device;
identifying a list of objects located on the portable media device that are associated with the received character string;
displaying to the user the received character string and the list of identified objects; and
allowing the user to move between the displayed character string and the displayed list of objects, wherein the user may modify the character string when the user has navigated to the character string and the user may select an object from the list of objects when the user has navigated to the list of objects.

21. The method of claim 20 wherein receiving a character string from a user comprises:
displaying to the user a list of individually-selectable characters;
allowing the user to select one or more characters from among the displayed list; and
displaying the one or more characters selected by the user.

22. The method of claim 21 wherein the list of individually-selectable characters is a lowercase alphabet presented in alphabetical order.

23. The method of claim 21 wherein the list of individually-selectable characters is an uppercase alphabet presented in alphabetical order.

24. The method of claim 21 wherein the list of individually-selectable characters is a list of single integers presented in numerical order.

25. The method of claim 21 wherein the list of individually-selectable characters is a list of symbols.

26. The method of claim 21 wherein a user may select one or more characters only when the user has navigated to the list of individually-selectable characters.

27. The method of claim 20 wherein the user may traverse the displayed list of objects, and wherein the character string is displayed to the user in a fixed location as the user traverses the list.

28. The method of claim 21 wherein the user may traverse the displayed list of objects, and wherein the list of individually-selectable characters and the characters selected by the user are displayed to the user in a fixed location as the user traverses the list.

29. The method of claim 20 wherein the user may traverse the displayed list of objects, and wherein the character string is no longer displayed to the user after the user traverses a certain distance in the list.

30. The method of claim 21 wherein the user may traverse the list of displayed objects, and wherein the list of individually-selectable characters and the characters selected by the user are no longer displayed after the user traverses a certain distance in the list.

31. The method of claim 21 wherein one or more pre-selected characters are displayed to the user before the user has selected a character from among the displayed list.

32. The method of claim 21 wherein no characters are displayed to the user before the user has selected a character from among the displayed list.

33. The method of claim 21 wherein a user action associated with an individually-selectable character causes selection of a character other than the individually-selectable character to be entered.

34. The method of claim 20 further comprising generating a list of objects each time the user adds a new character to the character string or modifies the character string.

35. The method of claim 34 wherein the list of objects is displayed each time a list of objects is generated.

36. The method of claim 20 wherein objects are associated with the received character string when a first word in a title of the object begins with the received character string.

37. The method of claim 20 wherein objects are associated with the received character string when any word in a title of the object begins with the received character string.

38. The method of claim 20 wherein the objects are media files.

39. A method of locating and selecting objects on a portable computing device that has a screen with limited display capacity, the method comprising:
allowing a user to navigate horizontally to enter one or more characters on the screen, wherein the characters are indicative of one or more objects located on the portable computing device;
identifying one or more objects located on the portable computing device that are associated with the entered characters;
displaying to the user the entered characters horizontally on the screen and the identified one or more objects in a vertical list on the screen, wherein the entered characters and the list of objects are displayed concurrently on the screen; and
allowing the user to navigate vertically to select among the list of objects and horizontally to modify the entered characters.

40. The method of claim 39 wherein allowing the user to navigate horizontally to enter one or more characters comprises:
displaying to the user a horizontal list of individually-selectable characters;
allowing the user to select one or more characters from the displayed list; and
displaying horizontally on the screen the one or more characters selected by the user.

41. The method of claim 39 wherein the user may traverse the displayed list of objects, and wherein the entered characters are displayed to the user in a fixed location on the screen as the user traverses the list.

42. The method of claim 40 wherein the user may traverse the displayed list of objects, and wherein the list of individually-selectable characters and the characters selected by the user are displayed to the user in a fixed location on the screen as the user traverses the list.

43. The method of claim 39 wherein the user may traverse the displayed list of objects, and wherein the entered characters are no longer displayed to the user on the screen after the user traverses a certain distance in the list.

44. The method of claim 40 wherein the user may traverse the list of displayed objects, and wherein the list of individually-selectable characters and the characters selected by the user are no longer displayed on the screen after the user traverses a certain distance in the list.

45. The method of claim 40 wherein a user action associated with an individually-selectable character causes selection of a character other than the individually-selectable character to be entered.

46. The method of claim 39 further comprising identifying one or more objects each time the user enters a new character or modifies a previously entered character.

47. The method of claim 46 wherein the list of objects is displayed each time one or more objects is identified.

48. The method of claim 40 wherein a user may select one or more characters only when the user has navigated to the list of individually-selectable characters.

49. A system for locating and selecting objects on a portable computing device that has a screen with limited display capacity, the system comprising:
an input component that allows the user to navigate horizontally to enter one or more characters on a screen of the portable computing device, wherein the characters are indicative of one or more objects located on the device;
a filtering component for identifying one or more objects located on the portable computing device that are associated with the entered characters;
a display component for displaying to the user the entered characters horizontally on the screen and a list of the identified one or more objects vertically on the screen, wherein the entered characters and the list of identified objects are displayed concurrently on the same screen; and
a navigation component for allowing the user to navigate vertically to select from among the list of displayed objects and horizontally to modify the one or more displayed characters.

50. The system of claim 49 wherein the input component comprises:
a text-entry component comprising a list of individually-selectable characters that allows the user to enter a character; and
a string display component that displays one or more entered characters by the user.

51. The system of claim 50 wherein the list of individually-selectable characters is only enabled when the user has navigated to the list of individually-selectable characters.

52. The system of claim 49 wherein the user may traverse the list of displayed objects and the entered characters are displayed to the user in a fixed location on the screen as the user traverses the list.

53. The system of claim 50 wherein the user may traverse the list of displayed objects and the text-entry component and string display are displayed to the user in a fixed location on the screen as the user traverses the list.

54. The system of claim 49 wherein the user may traverse the list of displayed objects and the entered characters are no longer displayed to the user on the screen after the user traverses a certain distance in the list.

55. The system of claim 50 wherein the user may traverse the list of displayed objects and the text-entry component and string display are no longer displayed on the screen after the user traverses a certain distance in the list.

56. The system of claim 50 wherein a user action associated with an individually-selectable character causes a character other than the individually-selectable character to be entered.

57. The system of claim 49 wherein the filtering component identifies one or more objects each time the user enters a new character or modifies a previously entered character.

58. The system of claim 57 wherein the display component displays the list of objects each time the filtering component generates one or more objects.
